(19) United States
(12) Patent Application Publication
(10) Pub. No.: US 2023/0338756 A1
(43) Pub. Date: Oct. 26, 2023

(54) APPARATUS FOR VAPOR-TIGHT GAS CONTAINMENT

(71) Applicant: NOVA Chemicals (International) S.A., Fribourg (CH)

(72) Inventors: Evan MAH, Calgary (CA); Thomas CHEE, Calgary (CA); Adam MILLER, Cochrane (CA); Paul MESQUITA, Calgary (CA)

(73) Assignee: NOVA Chemicals (International) S.A., Fribourg (CH)

(21) Appl. No.: 17/787,890

(22) PCT Filed: Nov. 30, 2020
(86) PCT No.: PCT/IB2020/061293

§ 371 Date: Jun. 21, 2022

Related U.S. Application Data
(60) Provisional application No. 62/949,009, filed on Dec. 17, 2019.

(51) Int. Cl. A62C 2/04; A62C 2/06

(52) U.S. Cl. CPC A62C 2/04; A62C 3/14

(57) ABSTRACT

Disclosed herein are the design and construction methods for a specialized structure, or “cabinet”, to house compressed gas cylinders such that they may be kept within an ordinary building.

Disclosed herein are the design and construction methods for a specialized structure, or “cabinet”, to house in-service compressed gas cylinders such that they may be kept within an ordinary building.

Gas cylinders are used to contain substances that are gas phase at standard ambient temperature and pressure. The gas can either be compressed or liquified, both of which require very high pressures. The types of gases that can be contained in a gas cylinder are numerous and can carry various hazards depending on the gas chemistry. Hydrocarbon gases are flammable while other gases can be toxic. Regardless of what type of gas, the volume expansion as gas is released from a cylinder always carries the hazard of oxygen displacement with the obvious exceptions of compressed air or oxygen. For flammable gases and toxic gases, there are specialized regulations governing how and where they can be used since they often carry high risks if there were to be a leak. These regulations typically prevent compressed gas cylinders from being kept in areas normally meant for human occupation and require facilities separated and distant from such facilities.

### SUMMARY OF INVENTION

Provided herein are embodiments of a vented but vapour-tight and electrically classified room for the containment of flammable and toxic gases including:
four walls supported on a welded steel frame;
a ceiling supported on a welded steel frame;
a door to provide access to the room operated manually or motorized with explosion-proof casing;
means for ventilation that deliver at least 6 air changes per hour (ACH) provided the ventilation rate is adequate to prevent vapour-air concentrations from reaching 25% of the lower flammability limit (LFL) for the gases being stored;
means for gas detection that provide an automated shutoff response to be assigned to prevent 25% LFL atmospheres from escaping the cabinet in the event of a fitting leak; and
a fire suppression sprinkler installed close to the ceiling activated with the building fire suppression system,
wherein the room is within a non-classified building.

### BRIEF DESCRIPTION OF THE DRAWINGS

FIG. 1: As-built Viamaster™ LED lighting rated for use in hazardous area locations.

FIG. 2: Front elevation diagram of overhead door.

FIG. 3: Front side picture of overhead door as-built.

FIG. 4: Ducting detail for an electrically classified room.

FIG. 5: Bubble-tight air intake damper as-built.

### DESCRIPTION OF EMBODIMENTS

### Cabinet Construction

Disclosed herein are the design and construction methods for a specialized structure, or “cabinet”, to house in-service compressed gas cylinders such that they may be kept within an ordinary building. In one embodiment, a vapour-tight cabinet was constructed against two existing cinderblock walls in a building with a 30 foot high ceiling. In this embodiment there are no overhead or adjacent obstructions to consider however there is an open sump underneath the cabinet location. A person of ordinary skill would understand such obstructions would need to be taken into consideration if the cabinet were to be constructed in an area with such obstructions. Also contemplated by this disclosure are examples where there are no existing cinder block walls and the cabinet is constructed within another existing space. In other embodiments there maybe from 1 to 4 existing cinderblock walls.

As part of the design, powder coated 3/16″ plate steel flooring was used to isolate the cabinet from the sump. The size of the vapour-tight cabinet was required to be large enough to house two rows of nine K size gas cylinders for a total of 18. The size of the cabinet can be adjusted to meet specific needs.

In some embodiments, the connections to the gas cylinder valve and all point-of-source fittings are contained within the cabinet including; pressure regulators, safety release devices, manual shutoff valves and automated solenoid shutoff valves. It was considered that the most likely source of a leak would be valves and fittings rather than the seamless tubing or pipes used for the distribution system.

### Walls & Ceiling

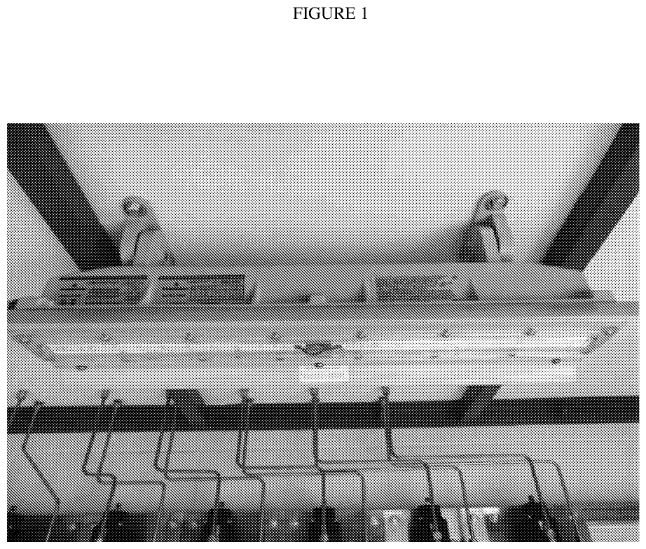

In some embodiments the walls and ceiling of the cabinet are supported on a welded steel frame. The steel frame can be bolted and sealed to the adjacent cinderblock walls. New walls and the ceiling were constructed from polyvinyl chloride (PVC) sheets, specifically, Ex-Cel® PVC Integral Free Foam sheets with butyl tape to seal all joints and low off-gassing silicone sealant to seal all wall penetrations and edges. The sheets can be attached to the outside of the steel framing using known methods. PVC sheets were not required against the cinderblock walls, but could be included if desired. Task lighting can be added as desired. In this example, two Emerson Appleton™ Viamaster™ LED fixtures were installed on the ceiling to provide dedicated task lighting in the cabinet. The typical lighting installation is shown in FIG. 1.

### Doors

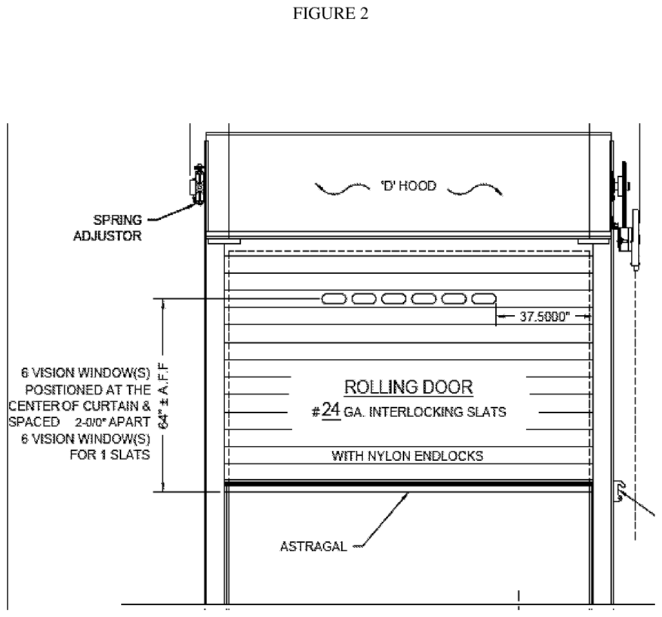

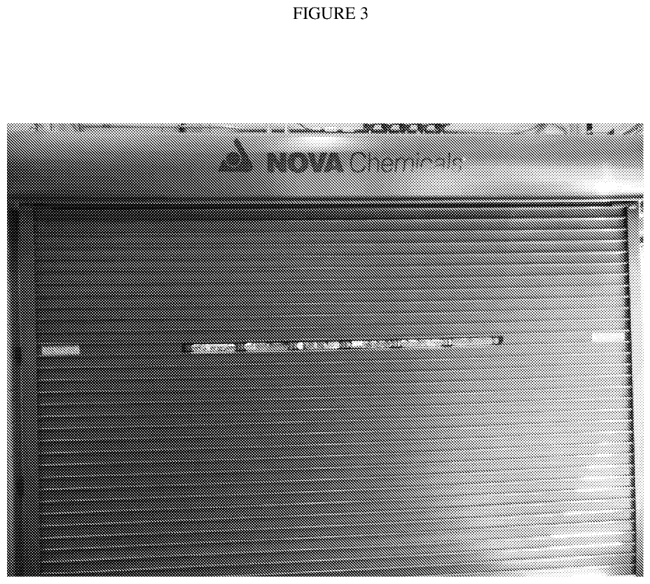

Personnel access to the room is through an overhead roll-up curtain of interlocking steel panels provided by Cornell. In some embodiments, the curtain has transparent windows built into one or more of the steel panels. In some embodiments, the door is operated manually. In other embodiments the door is motorized with explosion-proof casing. The runner guides for the curtain have weather stripping to provide a seal between the guide track and the door. The front elevation diagram is provided in FIG. 2 and an image of the as-built is shown in FIG. 3.

Any door that provides proper sealing can be used.

### Ventilation

Proper ventilation of the vapour-tight room was given special consideration. NFPA 497 suggests 6 air changes per hour (ACH) for hazardous locations but also qualifies the recommendation by requiring that the final ventilation rate be adequate to prevent vapour-air concentrations from reaching 25% of the lower flammability limit (LFL) which can be calculated using any method known in the art and which may be listed in chemical safety regulations. The exhaust rate that was determined to be adequate for the dimensions of an example cabinet, that was 160 inches in height, 144 inches wide and 48 inches deep, was 114 ACH. This was the value that was required to prevent the accumulation of 25% of the LFL concentration.

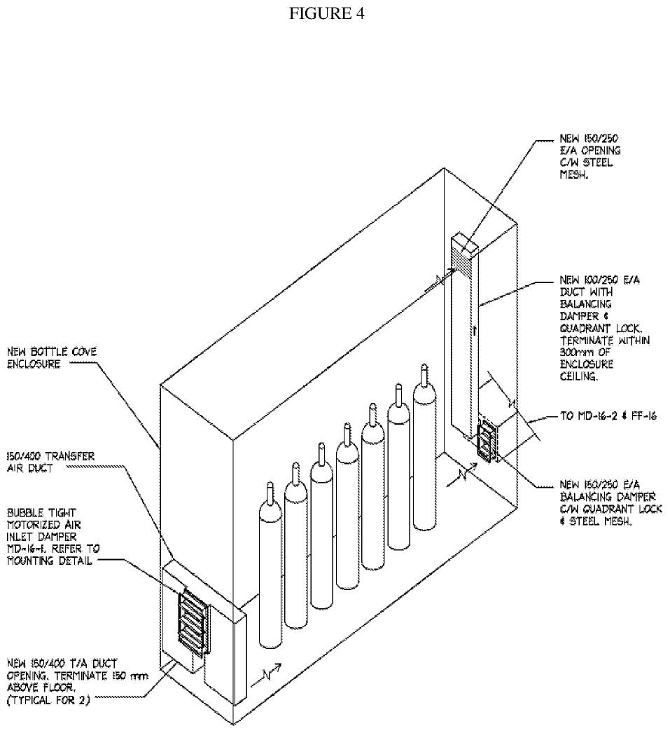

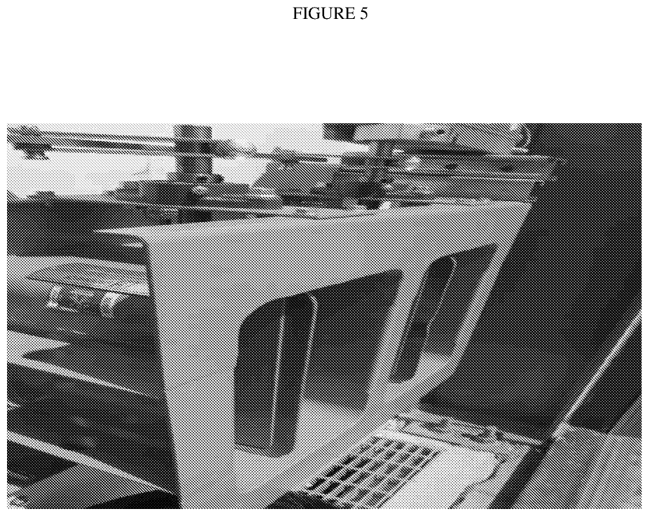

FIG. 4 shows the ducting layout for the ventilation. Exhaust air is located on the opposite wall from the air intake such that the exhaust sweeps across the gas cylinders. Two exhaust grilles are placed at 30 cm above grade and 200 cm above grade and ducted into a common duct with a fire damper. Under normal conditions the enclosure would not have flammable, explosive, or toxic gases in the atmosphere. If a leak occurs from a valve, fitting, seal, etc. on one or more of the gas cylinders as described in the last paragraph of the cabinet construction section. In the unlikely event that of both a leak and simultaneously the fan failure then the bubble tight dampers would prevent gas migration to surrounding areas and areas connected by ventilation ducting. It would keep the environment contained until the fan is back up and running or an operator intervenes and opens the door to ventilate to atmosphere if/when safe to do so. Gas monitors as described in the next section will allow operators to observe the level of flammable gas within the cabinet. The bubble tight intake damper is shown in FIG. 5. Other known ventilation systems can be used to ventilate the room. Ventilation systems useful for the storage rooms of this disclosure should be able to maintain the vapor tight barrier, especially when in the closed position.

### Gas Detection & Fire Suppression

In some embodiments, the room may also be equipped with atmospheric gas detectors for real-time monitoring of flammable gases. Connection to a programming logic controller allows for automated shutoff responses to be assigned to prevent 25% LFL atmospheres from escaping the cabinet in the event of a fitting leak. On a gas detector LFL alarm or fault, automated solenoid shutoff valves close to cutoff flammable gas flow to the downstream processes and a notification is sent to operations. The exhaust fan and dampers stay active to ventilate the enclosure to prevent lower explosion limit gas concentrations. The atmospheric detection system can easily be expanded to include sensors for oxygen levels or toxic gases. Non limiting examples of toxic gases include carbon monoxide, chlorine, and hydrogen sulfide.

Fire suppression sprinklers can be installed close to the ceiling in the headspace of the cabinet. In some embodiments, this system is activated with the building fire suppression system to keep the contents of the cabinet cool and mitigate impact from adjacent fires.

### Hydrogen Gas

While the purpose of the vented cabinet is to segregate any potentially hazardous atmosphere from the regular building space, hydrogen gas presents a unique danger due to its small molecule size and ignition properties. Risk analysis shows a K sized gas cylinder of hydrogen gas represents a high risk and housing one in this cabinet may not be safe. Using a smaller gas cylinder may not significantly reduce the hazard since it increases the frequency of exchanging spent cylinders for fresh ones. In some embodiments the one can replace the hydrogen cylinder for an on-demand hydrogen generator. The inventory of hydrogen maintained with the hydrogen generator is only the volume of the distribution system and a small amount within the integrated compressor. Although the hazard of hydrogen gas was significantly reduced, installing a generator is complex.

### INDUSTRIAL APPLICABILITY

The present invention relates to storage of compressed gas cylinders. More specifically, the present invention relates to a specialized structure suitable for storage and or housing of in-service compressed gas cylinders within an ordinary building.

1. A vented but vapour-tight and electrically classified room for the containment of flammable and toxic gases comprising:
four walls supported on a welded steel frame;
a ceiling supported on a welded steel frame;
a door to provide access to the room operated manually or motorized with explosion-proof casing;
means for ventilation of the room that deliver a ventilation rate of at least 6 air changes per hour (ACH) provided the ventilation rate is adequate to prevent vapour-air concentrations within the room from reaching 25% of the lower flammability limit (LFL) for the gases being stored;
means for gas detection that provide an automated shutoff response to be assigned to prevent atmospheres containing vapour-air concentrations of 25% or greater of the LFL for the gases being stored from escaping the room in the event of a fitting leak; and
a fire suppression sprinkler installed close to the ceiling activated with the building fire suppression system,
wherein the room is within a non-classified building.

2. The room of claim 1 wherein at least one wall is bolted and sealed to adjacent cinderblock walls.

3. The room of claim 2 wherein no foam sheets are installed against the cinderblock walls.

4. The room of claim 1 wherein the walls are prepared from polyvinyl chloride foam sheets attached to the outside of the steel framing.

5. The room of claim 4 wherein the walls are prepared from Ex-Cel® PVC Integral Free Foam sheets attached to the outside of the steel framing.

6. The room of claim 1 wherein the ceiling is prepared from polyvinyl chloride foam sheets.

7. The room of claim 6 wherein the ceiling is prepared from Ex-Cel® PVC Integral Free Foam sheets.

8. The room of claim 1 wherein butyl tape is used to seal joints.

9. The room of claim 1 wherein low off-gassing silicone sealant is used to seal wall penetrations and edges.

10. The room of claim 1 further comprising task lighting installed on the ceiling.

11. The room of claim 1 wherein the door is an overhead roll-up curtain of interlocking steel panels.

12. The room of claim 11 wherein the door includes runner guides for the curtain and the runner guides have weather stripping to provide a seal between a runner track provided by the runner guides and the door.

13. The room of claim 11 wherein the door has transparent windows built into one or more of the steel panels.

14. The room of claim 1 wherein the exhaust ventilation rate is at least 100 ACH.

15. The room of claim 1 wherein the exhaust ventilation rate is between 6 and 115 ACH.

16. The room of claim 1 wherein the means for gas detection includes sensors for oxygen levels.

17. The room of claim 1 wherein the means for gas detection further includes sensors for a toxic gas.

18. The room of claim 17 wherein the sensors for a toxic gas are chosen from sensors for carbon monoxide, hydrogen sulfide, and chlorine.

19. The room of claim 1 further comprising a floor supporting the steel framing.

20. The room of claim 1 wherein the room is a cabinet.
